(19) United States
(12) Patent Application Publication
(10) Pub. No.: US 2007/0271135 A1
(43) Pub. Date: Nov. 22, 2007

(54) Card incentive database system

(76) Inventor: Amit Bracha, Irvine, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/435,253

(22) Filed: May 16, 2006

(51) Int. Cl. G06Q 30/00

(52) U.S. Cl. 705/14

(57) ABSTRACT

A card incentive data base system includes a computerized data base system with a client information table and a credit/debit card information table. The client information table includes a client identifier code and can accommodate card identifier codes for accounts owned by the client. The card information table includes card identifier codes and card incentive data. Means are provided for inputting and updating the tables as well as means for searching the system to determine at least one credit/debit card to use for a purchase based upon incentives available. The system may be accessed remotely over a network or telephone system. Text messaging, voice recognition and live operators are employed to allow the client to query the system prior to making a purchase. The system is capable of automatically updating its tables as incentive programs change. The system suggests new credit/debit card accounts to the client to optimize benefits available.

### FIELD OF INVENTION

The invention pertains to systems for optimizing the use of credit cards, debit cards and related offers and incentives. More particularly, the invention relates to an online database and integrated query systems for selecting and using an optimum card for a particular purchase based upon incentives offered in conjunction with the cards.

### BACKGROUND OF THE INVENTION

Various inventions have been developed to address the myriad of credit/debit card account related incentive and benefit programs that have been implemented by account providers. This complex and time consuming activity requires a variety of inputs, updates and query systems in order to be of real value to the consumer. The present invention provides a several useful query methods as well as sophisticated rule-based algorithms to determine optimum card selection for the user.

U.S. Patent Application Number No. 2002/0062249, issued to Iannacci, discloses a system and process that provides an on-line, interactive, and fully integrated benefit-driven value exchange and settlement program that monitors, evaluates, and manages economic and personal benefits and executes functions to produce and acquire the maximum or preferred benefit items for users by guiding and automating appropriate payment and settlement actions.

The present invention finds useful patterns in data; produces conclusions based on rules and experience; responds to environmental changes with or without human intervention; and, may evolve through selecting the best results from random mutations all of which are intended to maximize user value.

U.S. Patent Application Number No. 2003/0055783, issued to Cataline et al. is directed systems and methods for managing transactions. The system includes a data input portion that communicates first information regarding a payment request, as well as a decision reference data store for communicating second information regarding parameters for use in determining a payment option for the payment request. The system also includes a processor. The processor inputs the first information and the second information. Then, the processor selectably determines the payment option to direct a transmission of funds from at least one payment source to at least one payee account based on an optimization determination performed by the processor. The optimization determination may provide savings to the institution processing the transaction, or alternatively, may provide savings to the customer initiating the transaction, for example.

U.S. Patent Application Number No. 2002/0013728, issued to Wilkman illustrates systems and methods for providing transaction control for purchasing decisions that involve the use of credits, debits, loyalty points, affinity points, promotions, or currency transfers. The present invention provides a common forum where merchants desiring to target consumers prior to or at the time of purchase are matched with customers who desire information, goods, or services related to the merchant. In general, the matching and coordinating of the credit accounts, debit accounts, loyalty (points) programs, affinity (points) programs, promotions, and currency exchanges are performed such that consumers and businesses may obtain the greatest financial, promotional, or desired benefit on purchases of goods and services. Further, merchants may present promotional opportunities to consumers or businesses prior to, at the time of or after transacting the payment of goods or services.

U.S. Patent Application Number No. 2006/0020542, issued to Litle et al. disclose a method and system for processing financial transactions by receiving a payment transaction as an Issuing Payment Processor, converting the payment into one or more derivative transactions based on a defined rules set, and then sending, as a Merchant Payment Processor, the resulting derivative transaction or transactions to another Issuing Payment Processor, resulting in real-time settlement, faster and less costly implementation of discount, gift, and loyalty programs, and enhanced member credit card security and privacy.

It is an objective of the present invention to provide a convenient means for a consumer to determine the optimal credit/debit card to use for a particular type of purchase. It is a further objective to provide such a system that can be queried from remote locations using telephonic or Internet facilities. It is a still further objective of the invention to provide a system that will suggest new account openings to the consumer based upon available incentive plans. Finally, it is an objective of the present invention to provide a system that will be updated for all changes to incentive benefits as they occur and make such information available to consumers.

While some of the objectives of the present invention are disclosed in the prior art, none of the inventions found include all of the requirements identified.

### SUMMARY OF THE INVENTION

The present invention addresses all of the deficiencies of prior art card incentive data base system inventions and satisfies all of the objectives described above.

(1) A card incentive data base system providing all of the desired features can be constructed from the following components. A computerized data base system is provided. The system has a client information table and a credit/debit card information table. The client information table includes at least one client identifier. The card information table includes card identifiers and card incentive data. Means are provided for inputting and updating the tables. Means are provided for searching the system to determine at least one credit/debit card to use for a purchase based upon card incentives available.

(2) In a variant of the invention, the client information table further comprises at least one card identifier.

(3) In another variant, the system is accessed remotely over a network.

(4) In still another variant, the system is accessed through at least one of a telephone system and a remote access system.

(5) In yet another variant, the system is accessed through a text messaging system.

(6) In a further variant, the system is accessed through a voice recognition system.

(7) In still a further variant, the system is accessed through a connection to a live support person.

(8) In yet a further variant, the client information table further comprises an expiration date associated with each card identifier code.

(9) In another variant, the client information table further comprises client contact information.

(10) In still another variant, the card information table further comprises card provider contact information.

(11) In yet another variant, the card information table is updated as limited time incentives are either of added and removed by those offering credit/debit card accounts.

(12) In a further variant, the card information table includes financial benefit data. The financial benefit data may include any of the following: annual fee, signup promotions or bonuses, purchase interest rate, promotional purchase interest rate, promotional purchase interest rate termination date, balance transfer interest rate, promotional balance transfer interest rate, promotional balance transfer interest rate termination date, cash advance transfer rate, promotional cash advance interest rate and promotional cash advance interest rate termination date. The financial benefit data may also include cash refund data such as accumulation rules, accumulation limits and retrieval criteria. Further financial benefit incentives may also include annual fee amount, signup promotion, overdraft protection and eligibility requirements such as credit score requirements, income requirements, net worth requirements and residency requirements.

(13) In yet a further variant, the card information table includes guarantee benefit data. The guarantee benefit data may include any of the following: incentive mileage/gift point/cash back data such as accumulation rules, point expiration time periods, point usage levels, point usage restrictions, point usage fees, eligibility requirements, expiration dates and usage restrictions. The guarantee benefit data may also include price guarantee data such as price guarantee period, guarantee amount and guarantee criteria. Other guarantee benefits data may include such things as purchase return protection, purchase price protection, fraud protection, auto rental insurance coverage and travel accident insurance and warranty manager services.

(14) In still a further variant, the card information table further comprises limited time incentive data. These limited time incentives may include multiple incentive points, multiple mileage, gift certificates, buy one get one free and similar promotions and limited time discounts.

(15) In another variant of the invention, the means for searching the system to determine a credit/debit card to use for a purchase based upon card incentives available includes a rule set to evaluate all credit/debit cards of record in the system.

(16) In still another variant, the means for searching the system to determine a credit/debit card to use for a purchase based upon card incentives available includes a rule set to evaluate all credit/debit cards of record in the system in view of search criteria selected by the user.

(17) In yet another variant, the system will inform the user of criteria for applying for a selected credit/debit card.

(18) In a final variant of the invention, the system will inform the user of criteria for applying for a selected credit/debit card.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is an illustration of various means for communicating with the card incentive data base system of the present invention;

FIG. 2 is a schematic view of the client information table and the credit/debit card information table of the FIG. 1 embodiment;

FIG. 3 is a schematic view of the financial benefit data, guarantee benefit data and limited time incentive data of the FIG. 1 embodiment;

FIG. 4 is a schematic view of further details of the financial benefit data of the FIG. 1 embodiment; and

FIG. 5 is a schematic view of account selection rules for the present invention.

### DETAILED DESCRIPTION OF THE PREFERRED EMBODIMENT

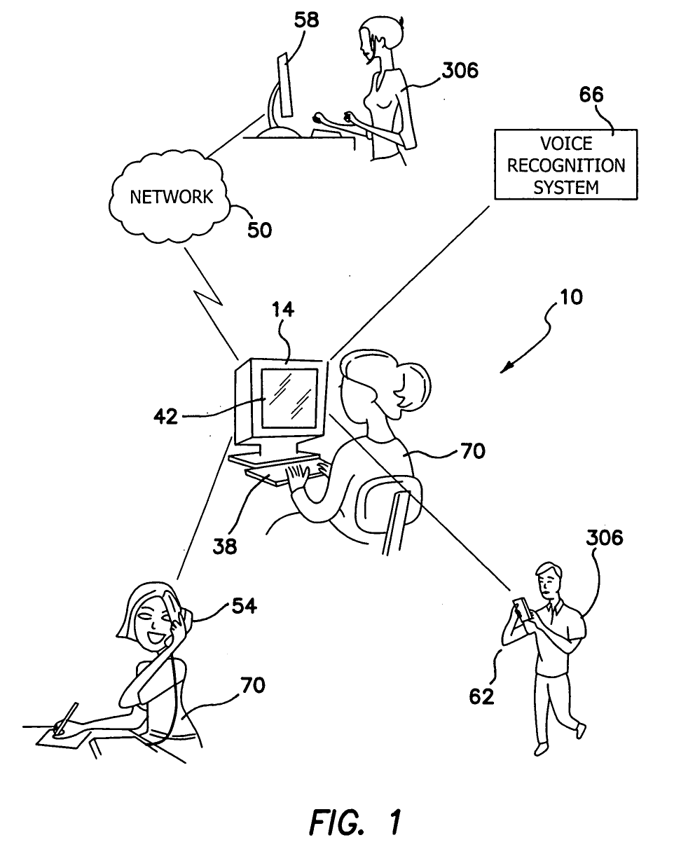

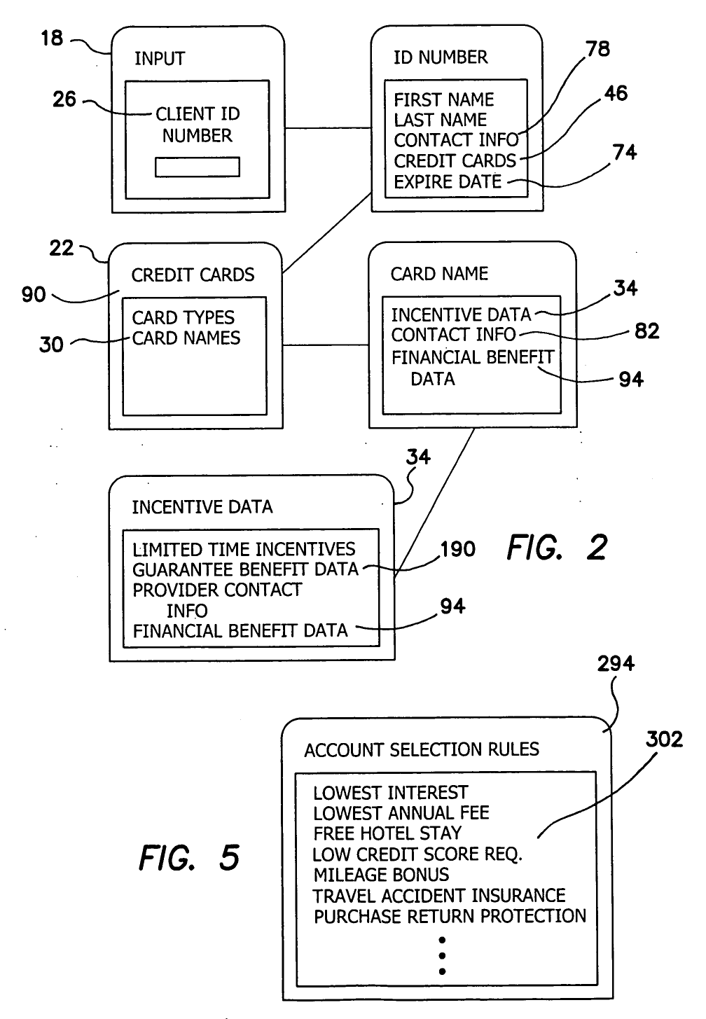

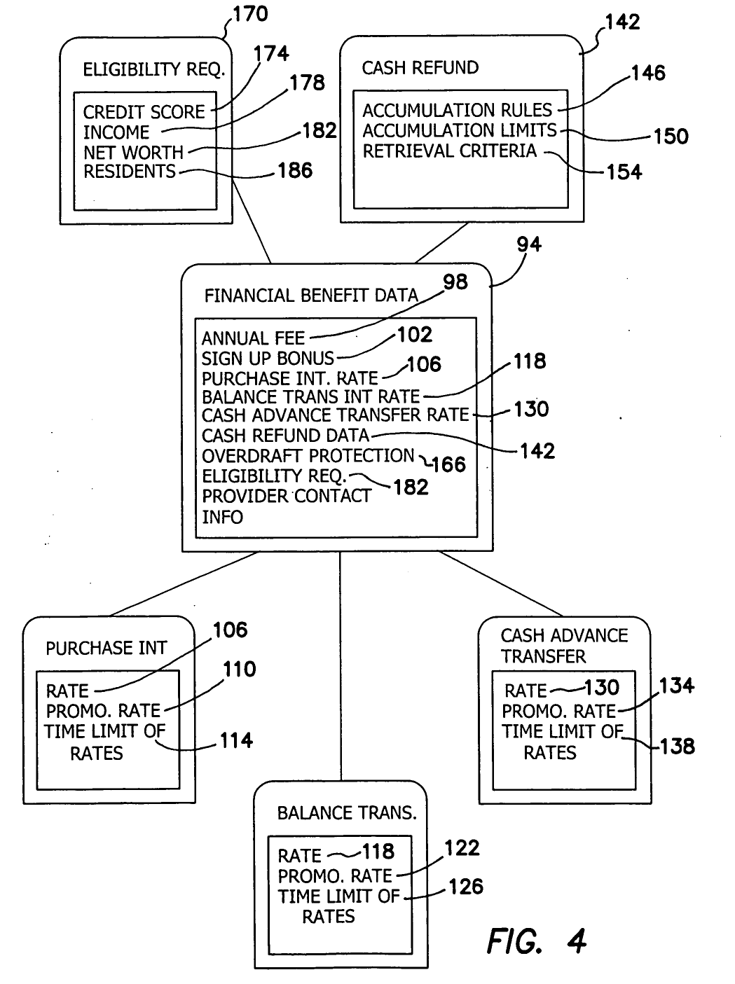

(1) FIGS. 1-5 illustrate a card incentive data base system 10 providing all of the desired features that can be constructed from the following components. As illustrated in FIGS. 1 and 2, a computerized data base system 14 is provided. The system has a client information table 18 and a credit/debit card information table 22. The client information table 18 includes a client identifier 26. The card information table 22 includes card identifiers 30 and card incentive data 34. Means 38 are provided for inputting and updating the tables 18, 22. Means 42 are provided for searching the system 10 to determine at least one credit/debit card 46 to use for a purchase based upon card incentives 34 available.

(2) In a variant of the invention, as illustrated in FIG. 2, the client information table 18 further comprises at least one card identifier 30.

(3) In another variant, as illustrated in FIG. 1, the system 10 is accessed remotely over a network 50.

(4) In still another variant, the system 10 is accessed through at least one of a telephone system 54 and a remote access system 58.

(5) In yet another variant, the system 10 is accessed through a text messaging system 62.

(6) In a further variant, the system is accessed through a voice recognition system 66.

(7) In still a further variant, the system 10 is accessed through a connection to a live support person 70.

(8) In yet a further variant, as illustrated in FIG. 2, the client information table 18 further comprises an expiration date 74 associated with each card identifier code 30.

(9) In another variant, the client information table 18 further comprises client contact information 78.

(10) In still another variant, the card information table 22 further comprises card provider contact information 82.

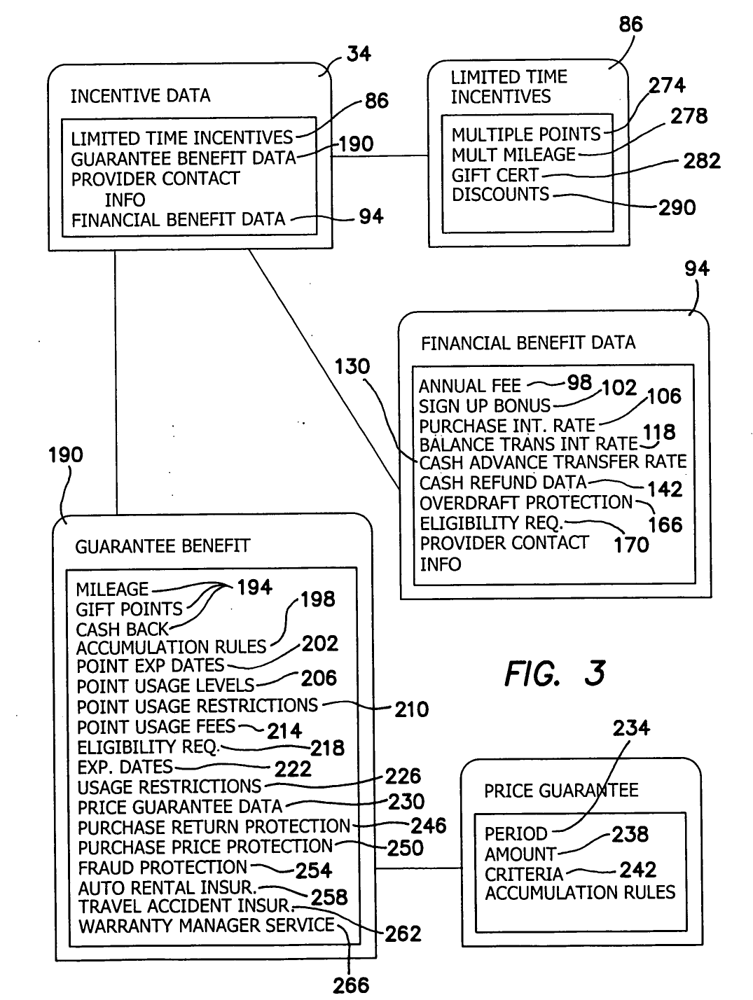

(11) In yet another variant, as illustrated in FIG. 3, the card information table 22 is updated as limited time incentives 86 are either of added and removed by those offering credit/debit card accounts 90.

(12) In a further variant, the card information table 22 includes financial benefit data 94. The financial benefit data may include any of the following: annual fee 98, signup promotions or bonuses 102, purchase interest rate 106, promotional purchase interest rate 110, promotional purchase interest rate termination date 114, balance transfer interest rate 118, promotional balance transfer interest rate 122, promotional balance transfer interest rate termination date 126, cash advance transfer rate 130, promotional cash advance interest rate 134 and promotional cash advance interest rate termination date 138. The financial benefit data may also include cash refund data 142 such as accumulation rules 146, accumulation limits 150 and retrieval criteria 154. Further financial benefit incentives may also include annual fee amount 98, signup promotion 102, overdraft protection 166 and eligibility requirements 170 such as credit score requirements 174, income requirements 178, net worth requirements 182 and residency requirements 186.

(13) In yet a further variant, the card information table 22 includes guarantee benefit data 190. The guarantee benefit data 190 may include any of the following: incentive mileage/gift point/cash back data 194 such as accumulation rules 198, point expiration time periods 202, point usage levels 206, point usage restrictions 210, point usage fees 214, eligibility requirements 218, expiration dates 222 and usage restrictions 226. The guarantee benefit data 190 may also include price guarantee data 230 such as price guarantee period 234, guarantee amount 238 and guarantee criteria 242. Other guarantee benefits data 190 may include such things as purchase return protection 246, purchase price protection 250, fraud protection 254, auto rental insurance coverage 258 and travel accident insurance 262 and warranty manager services 266.

(14) In still a further variant, the card information table 22 further comprises limited time incentive data 86. These limited time incentives 86 may include multiple incentive points 274, multiple mileage 278, gift certificates 282, buy one get one free and similar promotions (not shown) and limited time discounts 290.

(15) In another variant of the invention, as illustrated in FIG. 5, the means 42 for searching the system 10 to determine a credit/debit card 46 to use for a purchase based upon card incentives 34 available includes a rule set 294 to evaluate all credit/debit cards 46 of record in the system 10.

(16) In still another variant, the means 42 for searching the system 10 to determine a credit/debit card 46 to use for a purchase based upon card incentives 34 available includes a rule set 294 to evaluate all credit/debit cards 46 of record in the system 10 in view of search criteria 302 selected by the user 306.

(17) In yet another variant, the system 10 will inform the user 306 of criteria for applying for a selected credit/debit card 46.

(18) In a final variant of the invention, the system 10 will inform the user of criteria for applying for a selected credit/debit card 46.

The card incentive data base system 10 has been described with reference to particular embodiments. Other modifications and enhancements can be made without departing from the spirit and scope of the claims that follow.

1. A card incentive data base system, comprising:
a computerized data base system, said system having a client information table and a credit/debit card information table;
said client information table comprising at least one client identifier;
said card information table comprising card identifiers and card incentive data;
means for inputting and updating said tables; and
means for searching said system to determine at least one credit/debit card to use for a purchase based upon card incentives available.

2. The card incentive data base system, as described in claim 1, wherein said client information table further comprises at least one card identifier.

3. The card incentive data base system, as described in claim 1, wherein said system is accessed remotely over a network.

4. The card incentive data base system, as described in claim 3, wherein said system is accessed through at least one of a telephone system and a remote access system.

5. The card incentive data base system, as described in claim 4, wherein said system is accessed through a text messaging system.

6. The card incentive data base system, as described in claim 4, wherein said system is accessed through a voice recognition system.

7. The card incentive data base system, as described in claim 4, wherein said system is accessed through a connection to a live support person.

8. The card incentive data base system, as described in claim 2, wherein said client information table further comprises an expiration date associated with each card identifier code.

9. The card incentive data base system, as described in claim 1, wherein said client information table further comprises client contact information.

10. The card incentive data base system, as described in claim 1, wherein said card information table further comprises card provider contact information.

11. The card incentive data base system, as described in claim 1, wherein said card information table is updated as limited time incentives are either of added and removed by those offering credit/debit card accounts.

12. The card incentive data base system, as described in claim 1, wherein said card information table further comprises financial benefit data.

13. The card incentive data base system, as described in claim 1, wherein said card information table further comprises guarantee benefit data.

14. The card incentive data base system, as described in claim 1, wherein said card information table further comprises limited time incentive data.

15. The card incentive data base system, as described in claim 1, wherein said means for searching said system to determine a credit/debit card to use for a purchase based upon card incentives available comprises a rule set to evaluate all credit/debit cards of record in said system.

16. The card incentive data base system, as described in claim 15, wherein said means for searching said system to determine a credit/debit card to use for a purchase based upon card incentives available comprises a rule set to evaluate all credit/debit cards of record in said system in view of search criteria selected by said user.

17. The card incentive data base system, as described in claim 15, wherein said system will inform said user of criteria for applying for a selected credit/debit card.

18. The card incentive data base system, as described in claim 16 wherein said system will inform said user of criteria for applying for a selected credit/debit card.
